(19) United States
(12) Patent Application Publication
(10) Pub. No.: US 2023/0055296 A1
(43) Pub. Date: Feb. 23, 2023

(54) DRIVER DIRECTIONAL CONTROL VIA THE STEERING WHEEL DURING DIFFERENTIAL BRAKING AS STEER-BY-WIRE FALLBACK

(71) Applicants: Steering Solutions IP Holding Corporation, Auburn Hills, MI (US); Continental Automotive Systems, Inc., Auburn Hills, MI (US)

(72) Inventors: Joseph A. LaBarbera, Auburn Hills, MI (US); Clinton L. Schumann, Holly, MI (US); Scott T. Sanford, Swartz Creek, MI (US); Michael S. Wyciechowski, Grand Blanc, MI (US)

(21) Appl. No.: 17/826,597

(22) Filed: May 27, 2022

Related U.S. Application Data
(60) Provisional application No. 63/233,852, filed on Aug. 17, 2021.

(51) Int. Cl. B62D 9/00

(52) U.S. Cl. CPC B62D 9/005; B62D 5/0484

(57) ABSTRACT

A number of illustrative variations may include a system and method of using vehicle brakes to steer a vehicle where steer-by-wire steering systems have failed. The system may include supplying varying brake pressure, as needed, to different vehicle wheels to steer the vehicle. The system may include supplying engine system commands to maintain vehicle speed or acceleration such that in the event of steering system failure, a vehicle may continue to operate safely without effecting driver input.

### CROSS-REFERENCE TO RELATED APPLICATIONS

This application claims the benefit of U.S. Provisional Application Ser. No. 63/233,852 filed Aug. 17, 2021.

### TECHNICAL FIELD

The field to which the disclosure generally relates to includes steering, braking, and propulsion systems.

### BACKGROUND

Vehicles typically include steering systems including electronic power steering systems incorporating steer-by-wire technology.

### SUMMARY OF ILLUSTRATIVE VARIATIONS

A number of illustrative variations may include a system and method of using vehicle brakes to steer a vehicle where steering systems have failed. The system may include supplying varying brake pressure, as needed, to different vehicle wheels to steer the vehicle. The system may include supplying propulsion system commands to maintain vehicle speed or acceleration such that in the event of steering system failure, a vehicle may continue to operate safely without effecting driver input.

A number of illustrative variations may include a system and method of using a vehicle steering wheel as an input to a brake-to-steer system. Where a road wheel actuator within a steer-by-wire system is faulty or has failed, a brake-to-steer system may provide brake pressure requests applied to individual vehicle wheels dependent upon driver steering input. An electronic braking system may apply brake pressure to determined appropriate roadwheels to effectuate lateral movement of the vehicle as steering input by the driver via the handwheel. Brake pressure applied to individual wheels, or a plurality of wheels may be utilized to steer a vehicle temporarily in the event that a portion of the steer-by-wire system is faulty, has failed, or has shut down. Brake pressure requests may be calculated to provide an intuitive vehicle yaw response in a lateral direction that a driver steers.

Where a road wheel actuator or steering wheel actuator, or the combination of both, has failed, the system may utilize an external steering column sensor to determine driver intent of lateral travel of a vehicle.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of a block diagram of a system and method of brake-to-steer as steer-by-wire fallback;

FIG. 2 depicts an illustrative variation of a vehicle equipped with hardware sufficient for carrying out at least some of the systems and methods described herein; and

FIG. 3 depicts an illustrative variation of a system with hardware sufficient for carrying out at least some of the methods described herein.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle may comprise a steering system. In such cases, the steering system may be manually operable by the driver via a steering interface, autonomously operable by an autonomous steering system, or operable as a combination of autonomous and manual steering wherein the steering system is configured to receive and interpret steering input from a driver, the autonomous steering system, or both at the same time.

In a number of illustrative variations, a steering interface may comprise a handwheel, a joystick, a trackball, a slider, a throttle, a pushbutton, a toggle switch, a lever, a touchscreen, a mouse, or any other known means of user input.

In a number of illustrative variations, a vehicle may comprise a steering system comprising a steering interface and a steerable propulsion system such as but not limited to a steering wheel and road wheels, respectively. The steering system may be of the steer-by-wire type wherein physical mechanisms do not mechanically communicate a manipulation of the steering interface to the steerable propulsion system and wherein a manipulation of the steering interface affects an associated manipulation of the steerable propulsion system via the communication of electronic devices such as but not limited to sensors, transceivers, and electronically excited actuators. According to some variations, a steer-by-wire system may include at least one road wheel actuator and at least one a handwheel actuator in operable communication with one another via a steer-by-wire system or controller. The steer-by-wire system may include a road wheel actuator system in operable communication with a hand wheel actuator system wherein rotation of the steering wheel or handwheel of a vehicle translates to actuation of the road wheel actuator system such that a vehicle wheel may be turned.

The handwheel actuator assembly may include a steering wheel, a handwheel actuator, such as an electronic motor, and a hand wheel angle sensor. The handwheel actuator assembly may be constructed and arranged communicate handwheel angle and position to the road wheel actuator assembly including at least one steering actuator constructed and arranged to pivot or turn a road wheel.

In a number of illustrative variations, a vehicle may include electronic braking system constructed and arranged to apply brake pressure to any number of road wheels to slow or stop a vehicle based upon driver handwheel input. The electronic braking system may be in operable communication with the steer-by-wire system, hand wheel actuator assembly, and road wheel actuator assembly via at least one controller. The controller may implement any number of systems, including algorithms, for monitoring and controlling propulsion, steering, and braking. According to some variations, the electronic braking system may be utilized to apply differential brake pressure to a number of wheels to effectuate lateral motion of the vehicle where a portion of a steer-by-wire system has failed, such as an operable disconnect between the wheel actuator assembly and the roadwheel actuator assembly.

In a number of illustrative variations, a brake-to-steer system may utilize a brake-to-steer algorithm that may communicate brake pressure requests to individual wheels as a function of driver steering inputs including steering angle, steering angle rate, and steering torque. The brake-to-steer algorithm may communicate brake pressure requests when the system has detected a road wheel actuator failure or shut down leading to no output capable of a steering rack. Alternatively, the brake-to-steer algorithm may communicate brake pressure requests when the system has detected hand wheel actuator failure or shut down.

Upon detection of roadwheel actuator or handwheel actuator failure, the system may generate a visual or audio cue to a driver via a human to machine interface integrated into the vehicle. As a non-limiting example, the system may indicate via lamps or alarms that the steer-by-wire or a portion of the steer-by-wire system has failed. Driver input into the handwheel in the form of steering signals may include steering wheel angle, steering wheel rate, and steering torque may be communicated to a brake-to-steer driver directional controller. The brake-to-steer algorithm may receive said steering signals and calculate brake pressure requests as a function steering signals to an electronic braking system electronic control unit. An electronic braking system may provide a yaw response to driver input of steering signals. In some cases, the system may provide for control of a vehicles propulsion system and may adjust throttle, speed, acceleration, and the like as needed to maintain driving speed while the brake-to-steer system is operating. In some cases, the system may control a vehicles propulsion system to facilitate gradual slowing of a vehicle while the brake-to-steer system is operating.

According to some variations, a brake-to-steer system may be controlled by an external domain controller constructed and arranged to employ brake-to-steer functionality where a steer-by-wire system, including handwheel actuators and roadwheel actuators, loses power or fails entirely.

According to some variations, the brake-to-steer system may function by converting steering requests into a desired yaw rate which may then be converted into a corresponding brake pressure applied to the vehicle brakes in order to create the desired yaw rate. Brake pressure may be applied to vehicle brakes via an electronic braking system. Brake pressure may be applied to individual brake calipers as required to effectuate the desired yaw rate. The system may be constructed and arranged to also implement driver, or autonomous or virtual driver acceleration and deceleration requests as required.

Converting steering requests to actual yaw rate, and the conversion from your rate to brake pressure may be accomplished via calculation or look up tables. Similarly, converting steering angle to the appropriate brake pressures may also be accomplished via calculation or look up table. According to some variations, where an autonomous driving system or virtual driver system is implemented within a vehicle, calculated brake pressures may be communicated to the autonomous or virtual system such that the system may compensate for the brake-to-steer functionality.

According to some variations, the brake-to-steer system may continuously monitor vehicle speed, yaw rate, and lateral acceleration and may broadcast the availability of the brake-to-steer functionality to various other systems within the vehicle such that, if needed, brake-to-steer functionality may be implemented readily. According to some variations, the availability of the brake-to-steer system may include factoring in vehicle velocity data to determine the availability of the brake-to-steer system.

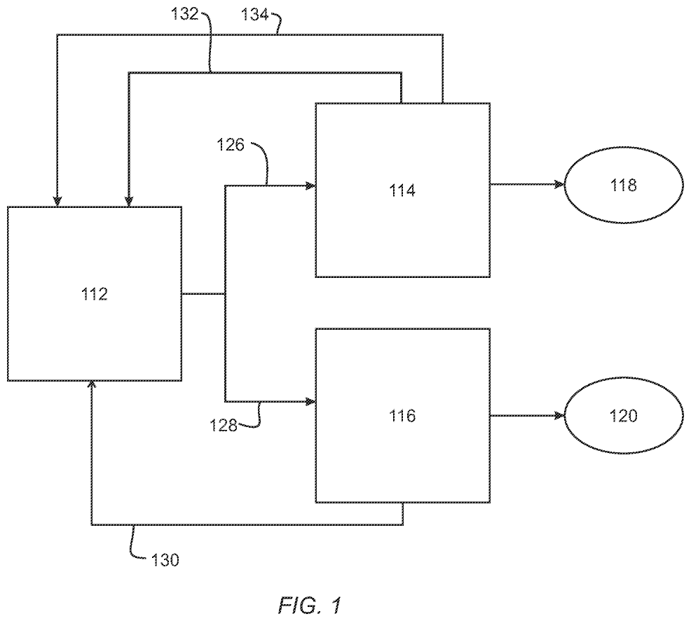

FIG. 1 depicts an illustrative variation of block diagram of a system and method of brake-to-steer as steer-by-wire fallback. A vehicle may include a controller 112 constructed and arranged to receive driver steering input 134 via a steer-by-wire system 114. The controller 112 may additionally be constructed and arranged to provide steering actuator commands 126 to the steer-by-wire system 114. The steer-by-wire system 114 may output tire angle changes 118 to affect steering and steer-by-wire system health status 132 to the controller 112. The controller 112 may also be constructed and arranged to provide braking commands 128 to an electronic braking system 116 which, in turn, may apply brake pressure 120 to individual brake calipers. Where the steer-by-wire system 114 has indicated to the controller 112 that steer-by-wire system health status 132 is at fault, the steer-by-wire system 114 is partially available or not available, the controller 112 may receive driver input 134 via a steering wheel and convert steering requests into brake pressure requests or commands 128 to be communicated to the electronic braking system 116.

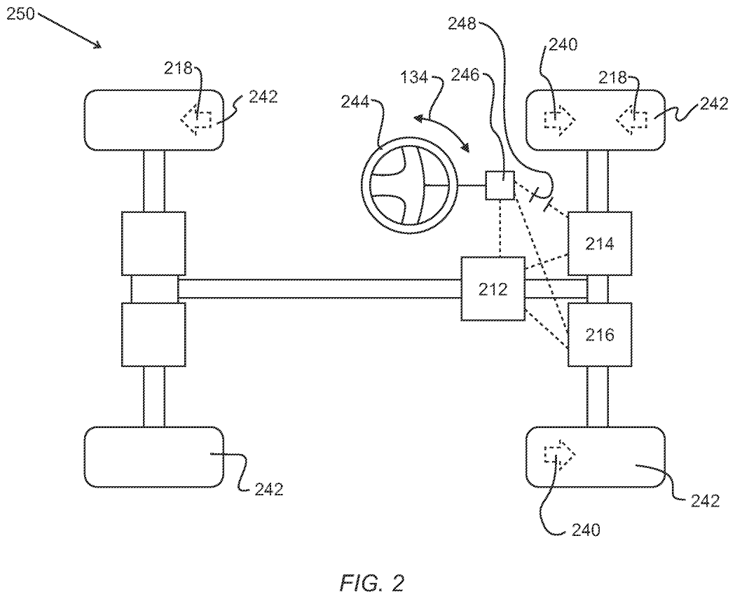

FIG. 2 depicts an illustrative variation of portions of a vehicle equipped with hardware sufficient for carrying out at least some of the systems and methods described herein. A vehicle 250 may include a controller 212 constructed and arranged to provide brake-to-steer functionality in a vehicle 250. The controller 212 may be in operable communication with a steer-by-wire system 214 and an electronic braking system 216. The steer-by-wire system 214 and an electronic braking system 216 may be in operable communication with at least one road wheel 242. A driver may utilize a handwheel 244 including at least one handwheel actuator 246 to provide driver input 134 for lateral movement and send steering requests to the steer-by-wire system 214. In some variations, the handwheel actuator 246 may be in operable communication with the controller 212, the steer-by-wire system 214, or the electronic braking system 216. In some variations, the handwheel actuator 246 may be disconnected or in a failure state 248 from or unable to communicate with the steer-by-wire system 214 or a roadwheel actuator as part of the steer-by-wire system 214. In such a variation, the handwheel actuator 246 may communicate steering requests to the controller 212, which may receive steer-by-wire system 214 health status information. Where the controller 212 has received steer-by-wire system 214 health status information indicative of steer-by-wire system 214 failure 248, and roadwheel actuator failure, the controller 212 may convert steering requests from the handwheel actuator 246 to brake pressure requests to be communicated to the electronic braking system 216. The electronic braking system 216 may apply brake pressure 218 to determined appropriate roadwheels 242 to effectuate lateral movement of the vehicle as input 134 by the driver via the handwheel 244. The controller 212 may also be constructed and arranged to make speed and acceleration requests 240 to an electronic engine system onboard such that the vehicle may maintain or modify speed or acceleration during brake-to-steer functionality.

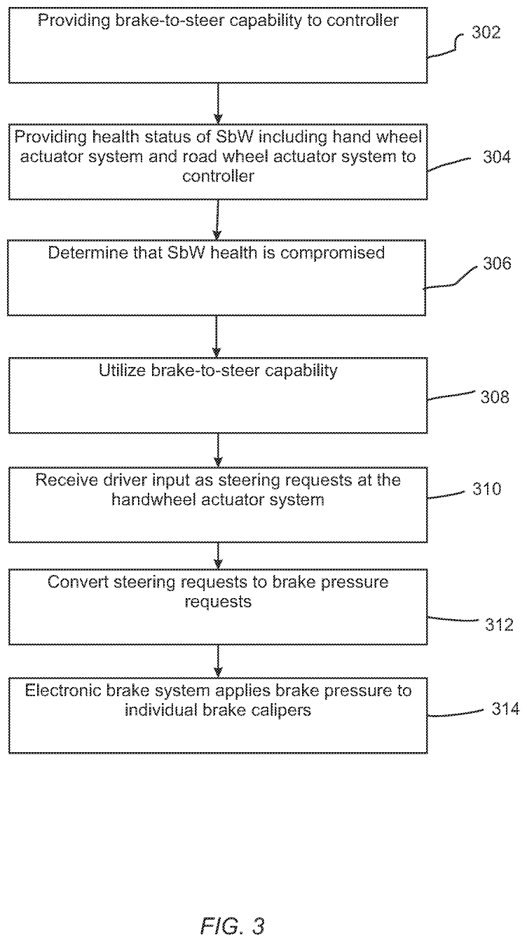

FIG. 3 depicts a simplified flowchart of an illustrative variation of a system for using brake-to-steer functionality as a steer-by-wire fallback. The system may routinely or approximately continuously provide brake-to-steer capability to a controller 302 indicating readiness of the brake-to-steer functionality. At point 304, the steer-by-wire (SbW) system health status, including roadwheel actuator system and handwheel actuator system health statuses, may be communicated to the motion controller. In some instances, the health status may indicate that the roadwheel actuator system, or portions thereof, are malfunctioning or not operable. At point 304, the controller may receive the steer-by-wire system health status and determine that the steer-by-wire system is at least partially compromised. The controller may then implement the brake-to-steer capability 308 including receiving 310 steering requests from the handwheel actuator system via driver input at the handwheel. At point 312, the system may convert steering requests to brake pressure requests. Alternatively, the system may convert steering requests to vehicle yaw rate requests and convert yaw rate requests to brake pressure requests. At point 314, the electronic brake system may receive brake pressure requests and apply brake pressure to individual brake calipers on a vehicle in order to steer a vehicle.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a method may include determining the availability of a brake-to-steer system within a vehicle; communicating the availability of the brake-to-steer system to a controller within the vehicle; determining availability of an electronic steering system within the vehicle; communicating the availability of the electronic steering system to the controller; and implementing brake-to-steer. Brake-to-steer may include receiving steering requests; converting steering requests to brake pressure requests; and applying brake pressure to at least one individual brake caliper within the vehicle according to the brake pressure requests to steer the vehicle.

Variation 2 may include a method as in variation 1, wherein receiving steering requests may include receiving steering requests from a handwheel and handwheel actuator system controlled by a driver.

Variation 3 may include a method as in any of variations 1 through 2, wherein receiving steering requests may include receiving steering requests from a handwheel actuator system.

Variation 4 may include a method as in any of variations 1 through 3, wherein implementing brake-to-steer may include utilizing an external steering column sensor to determine driver intent of lateral travel of a vehicle prior to determine steering requests.

Variation 5 may include a method as in any of variations 1 through 4, wherein determining the availability of a brake-to-steer system within a vehicle may include factoring in the vehicle's velocity.

Variation 6 may include a method as in any of variations 1 through 5, wherein determining availability of an electronic steering system within the vehicle may include identifying inoperable communication between a handwheel actuator system and a roadwheel actuator system.

Variation 7 may include a method as in any of variations 1 through 6, wherein determining availability of an electronic steering system within the vehicle may include identifying at least partial failure of a roadwheel actuator system.

Variation 8 may include a method as in any of variations 1 through 7, further including manipulating a propulsion system within the vehicle to maintain vehicle velocity while applying brake pressure to at least one individual brake caliper within the vehicle according to the brake pressure requests to steer the vehicle.

Variation 9 may include a method as in any of variations 1 through 8, wherein converting steering requests to brake pressure requests comprises converting steering requests to yaw rate requests and subsequently converting yaw rate requests to brake pressure requests.

Variation 10 may include a method as in any of variations 1 through 9, wherein converting vehicle yaw rate requests to brake pressure requests may include accessing a lookup table based upon vehicle yaw rate requests and retrieving brake pressure requests.

According to variation 11, a method for use in a vehicle having a plurality of vehicle systems comprising a braking system configured to manipulate a brake set, a steering system configured to adjust a roadwheel direction, a propulsion system configured to deliver driving power to at least one roadwheel, a brake-to-steer system, and a controller in operable communication with the braking system, steering system, and propulsion system, the method comprising: determining the availability of the brake-to-steer system within the vehicle; determining availability of the steering system within the vehicle; and using the controller to generate and communicate commands from the steering system to the controller, including receiving steering requests; generating an adjustment signal based upon steering requests; and using the vehicle systems to manipulate at least one the brake set, the steering system, or the propulsion system based upon the adjustment signal.

Variation 12 may include a method as in variation 11 wherein manipulating the brake set may include applying brake pressure to at least one individual brake caliper.

Variation 13 may include a method as in any of variations 11 through 12, wherein receiving steering requests may include receiving steering requests from a handwheel and handwheel actuator system controlled by a driver.

Variation 14 may include a method as in any of variations 11 through 13, wherein receiving steering requests may include receiving steering requests from a handwheel actuator system.

Variation 15 may include a method as in any of variations 11 through 14, wherein using the controller to generate and communicate commands from the steering system to the controller may include utilizing an external steering column sensor to determine driver intent of lateral travel of a vehicle prior to determine steering requests.

Variation 16 may include a method as in any of variations 11 through 15, wherein determining the availability of a brake-to-steer system within the vehicle may include factoring in the vehicle's velocity.

Variation 17 may include a method as in any of variations 11 through 16, wherein determining availability of the steering system within the vehicle may include identifying at least partial faulty communication between a handwheel actuator system and a roadwheel actuator system.

Variation 18 may include a method as in any of variations 11 through 17, wherein determining availability of the steering system within the vehicle may include identifying at least partial failure of a roadwheel actuator system.

Variation 19 may include a method as in any of variations 11 through 18, wherein using the vehicle systems to manipulate at least one the brake set, the steering system, or the propulsion system based upon the adjustment signal may include manipulating the propulsion system within the vehicle to maintain vehicle velocity while applying brake pressure to at least one individual brake caliper within the vehicle according to the brake pressure requests to steer the vehicle.

Variation 20 may include a method for use in a vehicle having a plurality of vehicle systems comprising a braking system configured to manipulate a brake set, a steering system configured to adjust a roadwheel direction, a propulsion system configured to deliver driving power to at least one roadwheel, a brake-to-steer system, and a controller in operable communication with the braking system, steering system, and propulsion system, the method comprising:

determining the availability of a brake-to-steer system within a vehicle; communicating the availability of the brake-to-steer system to a controller within the vehicle; determining availability of an electronic steering system within the vehicle; communicating the availability of the electronic steering system to the controller; and implementing brake-to-steer. Brake-to-steer may include receiving steering requests from a portion of the steering system; converting steering requests to brake pressure requests; manipulating the propulsion system and the braking system within the vehicle to maintain or change vehicle velocity while applying brake pressure to at least one individual brake caliper within the vehicle according to the brake pressure requests to steer the vehicle.

The above description of select variations within the scope of the invention is merely illustrative in nature and, thus, variations or variants thereof are not to be regarded as a departure from the spirit and scope of the invention.

What is claimed is:

1. A method comprising:
determining the availability of a brake-to-steer system within a vehicle;
communicating the availability of the brake-to-steer system to a controller within the vehicle;
determining availability of an electronic steering system within the vehicle;
communicating the availability of the electronic steering system to the controller;
receiving steering requests;
converting steering requests to brake pressure requests; and
applying brake pressure to at least one individual brake caliper within the vehicle according to the brake pressure requests to steer the vehicle.

2. A method as in claim 1, wherein receiving steering requests comprises receiving steering requests from a handwheel and handwheel actuator system controlled by a driver.

3. A method as in claim 1, wherein receiving steering requests comprises receiving steering requests from a handwheel actuator system.

4. A method as in claim 1, further comprising utilizing an external steering column sensor to determine driver intent of lateral travel of a vehicle prior to determine steering requests.

5. A method as in claim 1, wherein determining the availability of a brake-to-steer system within a vehicle comprises factoring in the vehicle's velocity.

6. A method as in claim 1, wherein determining availability of an electronic steering system within the vehicle comprises identifying inoperable communication between a handwheel actuator system and a roadwheel actuator system.

7. A method as in claim 1, wherein determining availability of an electronic steering system within the vehicle comprises identifying at least partial failure of a roadwheel actuator system.

8. A method as in claim 1, further comprising manipulating a propulsion system within the vehicle to maintain vehicle velocity while applying brake pressure to at least one individual brake caliper within the vehicle according to the brake pressure requests to steer the vehicle.

9. A method as in claim 1, wherein converting steering requests to brake pressure requests comprises converting steering requests to yaw rate requests and subsequently converting yaw rate requests to brake pressure requests.

10. A method as in claim 1, wherein converting steering requests to brake pressure requests comprises accessing a lookup table based upon steering requests and retrieving brake pressure requests.

11. A method for use in a vehicle having a plurality of vehicle systems comprising a braking system configured to manipulate a brake set, a steering system configured to adjust a roadwheel direction, a propulsion system configured to deliver driving power to at least one roadwheel, a brake-to-steer system, and a controller in operable communication with the braking system, steering system, and propulsion system, the method comprising:
determining the availability of the brake-to-steer system within the vehicle;
determining availability of the steering system within the vehicle;
using the controller to generate and communicate commands from the steering system to the controller and braking system, comprising:
receiving steering requests;
generating an adjustment signal based upon steering requests; and
using the vehicle systems to manipulate at least one the brake set, the steering system, or the propulsion system based upon the adjustment signal.

12. A method as in claim 11, wherein manipulating the brake set comprises applying brake pressure to at least one individual brake caliper.

13. A method as in claim 11, wherein receiving steering requests comprises receiving steering requests from a handwheel and handwheel actuator system input by a driver.

14. A method as in claim 11, wherein receiving steering requests comprises receiving steering requests from a handwheel actuator system.

15. A method as in claim 11, wherein using the controller to generate and communicate commands from the steering system to the controller comprises utilizing an external steering column sensor to determine driver intent of lateral travel of a vehicle prior to determine steering requests.

16. A method as in claim 11, wherein determining the availability of a brake-to-steer system within the vehicle comprises factoring in the vehicle's velocity.

17. A method as in claim 11, wherein determining availability of the steering system within the vehicle comprises identifying at least partial faulty communication between a handwheel actuator system and a roadwheel actuator system.

18. A method as in claim 11, wherein determining availability of a steering system within the vehicle comprises identifying at least partial failure of a roadwheel actuator system.

19. A method as in claim 11, wherein using the vehicle systems to manipulate at least one the brake set, the steering system, or the propulsion system based upon the adjustment signal comprises:
manipulating the propulsion system within the vehicle to maintain vehicle velocity while applying brake pressure to at least one individual brake caliper within the vehicle according to the brake pressure requests to steer the vehicle.

20. A method for use in a vehicle having a plurality of vehicle systems comprising a braking system configured to manipulate a brake set, a steering system configured to adjust a roadwheel direction, a propulsion system configured to deliver driving power to at least one roadwheel, a brake-to-steer system, and a controller in operable communication with the braking system, steering system, and propulsion system, the method comprising:
determining the availability of a brake-to-steer system within the vehicle;
communicating the availability of the brake-to-steer system to a controller within the vehicle;
determining availability of an electronic steering system within the vehicle;
communicating the availability of the electronic steering system to the controller; and
implementing brake-to-steer by:
receiving steering requests from a portion of the steering system;
converting steering requests to brake pressure requests;
manipulating the propulsion system and the braking system within the vehicle to maintain or change vehicle velocity while applying brake pressure to at least one individual brake caliper within the vehicle according to the brake pressure requests to steer the vehicle.
